(19) United States
(12) Patent Application Publication
(10) Pub. No.: US 2022/0209336 A1
(43) Pub. Date: Jun. 30, 2022

(54) Rechargeable Lithium-ion Battery

(71) Applicant: Hixon (Shenzhen) Technology Limited, Shenzhen (CN)

(72) Inventor: Qiu Deliang, Shenzhen (CN)

(21) Appl. No.: 17/343,826

(22) Filed: Jun. 10, 2021

(30) Foreign Application Priority Data
Dec. 28, 2020 (CN) 202011585180.6

(51) Int. Cl. H01M 50/107; H01M 50/166; H01M 10/0525; H01M 10/42; H01M 10/48; H02J 7/00

(52) U.S. Cl. CPC H01M 50/107; H01M 50/166; H02J 7/0042; H01M 10/425; H01M 10/488; H01M 10/0525

(57) ABSTRACT

This invention discloses a kind of rechargeable lithium-ion battery, which belongs to the technical field of rechargeable batteries. The rechargeable lithium-ion battery includes a PET sleeve, a PET gasket, a cell, a steel sleeve, a protective plate, an upper bracket, a lower bracket and a bottom gasket. The lower bracket and the bottom gasket are respectively fixed at both ends of the cell. The upper end of the lower bracket is fixed with the protective plate that includes a positive contact chip fixed in the middle of the surface, an LED indicator installed near the positive contact chip, and a universal charging and discharging base installed at the notch of the protective plate. The upper end of the protective plate is fixed with the upper bracket, which is clamped with the lower bracket. The upper and lower brackets are enclosed with the steel sleeve, whose lower end is closely riveted with the negative shell at one end of the cell head, and the upper end is fixed with the PET gasket. The positive contact chip passes through the middle of the steel sleeve and the PET gasket, and a through hole notch is made on the side of the steel sleeve, which is aligned and connected with the universal charging and discharging base interface. The whole battery is enclosed with the PET sleeve. With the universal charging and discharging base, LED indicator light and positive contact chip on the protective plate, this battery can directly be charged and discharged through the universal charging and discharging base via a USB cable. It is featured by simple and convenient charging and discharging, good and fast power transmission ability and short charging time. The LED indicator that indicates the charging state improves the convenience and practicability of the rechargeable battery. The steel sleeve integrates all parts of the battery as a whole and realizes negative electrode electricity conduction. The upper and lower brackets support and fix the protective plate, and also play an insulating role. The bottom gasket set at the lower end of the cell effectively protects the bottom of the battery from wear and deformation. The PET gasket is fixed at the top of the steel sleeve to play an insulating role. As the PET gasket is made of translucent material, the light of the LED indicator can penetrate the PET gasket and indicate the charging state.

### TECHNICAL FIELD

The invention belongs to the technical field of rechargeable batteries, in particular to a rechargeable lithium-ion battery.

### BACKGROUND TECHNOLOGY

A lithium-ion battery is a kind of secondary battery (rechargeable battery), which mainly works depending on the movement of lithium ions between the positive and negative electrodes. During charging and discharging, L+ is embedded and de-embedded between the two electrodes: during charging, Li+ is de-embedded from the positive electrode and embedded into the negative electrode through the electrolyte, and the negative electrode is in a rich lithium state; during discharging, it acts oppositely.

With the development of portable electronic products, rechargeable lithium-ion batteries have been widely used because of their high voltage, high capacity, repeatable charging and discharging, high safety, small self-discharge, no memory effect, fast charging and other characteristics. However, due to the high energy density, the lithium-ion batteries are easy to be damaged in case of overcharging, over-discharging, over-current, short circuit, ultra-high temperature charging and discharging and ultra-low temperature use. Therefore, the existing lithium-ion batteries are equipped with a protective plate to protect the cell protection interface. The common way is to install the protective plate on the head, bottom or side of the cell, and the battery itself can not indicate the charging state.

At present, the cylindrical battery needs to be protected by a protective plate for charging and discharging. The positive electrode needs to be connected to the protective plate of the negative electrode across the side of the cell through a nickel strip, or the protective plate needs to be placed on the positive electrode, and a nickel sheet is let out by spot welding on the bottom of the cell to connect to the protective plate on the positive electrode. The nickel sheet at the other end of the protective plate is led out and connected to the negative electrode end at the bottom of the cell, and a hardware contact chip is installed for output. This structure requires the nickel strip of the positive electrode to cross the surface of the cell, which has a hidden danger of short circuit caused by the nickel strip burr piercing the external insulating sleeve of the cell. Also, the battery can only be charged by a special charger, and can not be directly charged or discharged via a USB cable. Moreover, the battery itself can not indicate the charging state. Therefore, it is necessary to improve it.

### ABOUT THE INVENTION

This invention aims to provide a rechargeable lithium-ion battery that can be directly charged and discharged via a USB cable and can indicate the charging state.

For the above purpose, this invention provides the following technical scheme:

A rechargeable lithium-ion battery, which is composed of a PET sleeve, a PET gasket, a cell, a steel sleeve, a protective plate, an upper bracket, a lower bracket and a bottom gasket. The lower bracket and the bottom gasket are respectively fixed at both ends of the cell. The upper end of the lower bracket is fixed with a protective plate that includes a positive contact chip fixed in the middle of the surface, an LED indicator installed near the positive contact chip, and a universal charging and discharging base installed at the notch of the protective plate. The upper end of the protective plate is fixed with the upper bracket, which is clamped with the lower bracket. The upper and lower brackets are enclosed with the steel sleeve, whose lower end is closely riveted with the negative shell at one end of the cell head, and the upper end is fixed with the PET gasket, which is made of translucent material so that the light of the LED indicator can penetrate the PET gasket and indicate the charging state. The positive contact chip passes through the middle of the steel sleeve and the PET gasket, and a through hole notch is made on the side of the steel sleeve, which is aligned and connected with the universal charging and discharging base interface. The whole battery is enclosed with the PET sleeve.

The benefit of the invention: the rechargeable lithium-ion battery provided by the invention can be directly charged and discharged through the universal charging and discharging base via a USB cable, which is featured by simple and convenient charging and discharging, good and fast power transmission ability and short charging time. The LED indicator that indicates the charging state improves the convenience and practicability of the rechargeable battery. The steel sleeve integrates all parts of the battery as a whole and realizes negative electrode electricity conduction. The upper and lower brackets support and fix the protective plate, and also play an insulating role. The bottom gasket set at the lower end of the cell effectively protects the bottom of the battery from wear and deformation. The bottom gasket set at the lower end of the cell effectively protects the bottom of the battery from wear and deformation. The PET gasket is fixed at the top of the steel sleeve to play an insulating role. As the PET gasket is made of translucent material, the light of the LED indicator can penetrate the PET gasket and indicate the charging state.

### ABOUT ILLUSTRATIONS

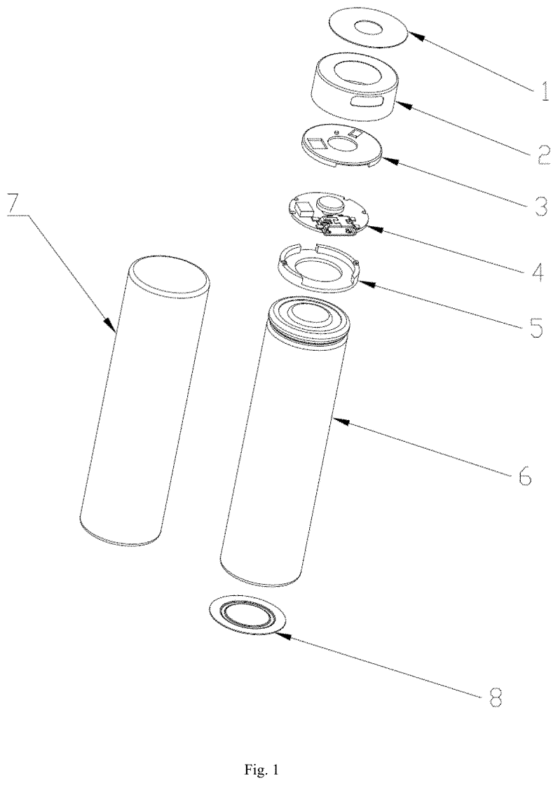

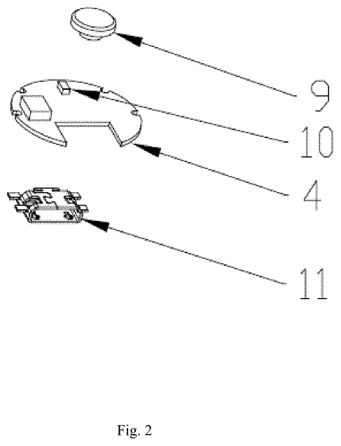

FIG. 1 and FIG. 2 are the exploded views of the invented rechargeable lithium-ion battery;

In the figures: 1. PET gasket; 2. steel sleeve; 3. upper bracket; 4. protective plate; 5. lower bracket; 6. cell; 7. PET sleeve; 8. bottom gasket; 9. positive contact chip; 10. LED indicator; 11. universal charging and discharging base.

### HOW TO IMPLEMENT

To further understand the invention, its features and effect, the following embodiment and attached exploded views are provided as follows for a detailed description.

Please refer to FIG. 1 and FIG. 2. The rechargeable lithium-ion battery as the embodiment of the invention is described in detail in combination with the attached figures as follows.

This rechargeable lithium-ion battery is composed of a PET gasket (1), a steel sleeve (2), an upper bracket (3), a protective plate (4), a lower bracket (5), a cell (6), a PET sleeve (7), a bottom gasket (8), a positive contact chip (9), an LED indicator (10) and a universal charging and discharging base (11); The lower bracket (5) and the bottom gasket (8) are respectively fixed at both ends of the cell (6). The upper end of the lower bracket (5) is fixed with the protective plate (4) that includes the positive contact chip (9) fixed in the middle of the surface, the LED indicator (10) installed near the positive contact chip (9), and the universal charging and discharging base (11) installed at the notch of the protective plate. The upper end of the protective plate (4) is fixed with the upper bracket (3), which is clamped with the lower bracket (5). The upper bracket (3) and the lower bracket (5) are enclosed with the steel sleeve (2), whose lower end is closely riveted with the negative shell at one end of the cell (6) head, and the upper end is fixed with the PET gasket (1). The PET gasket (1) is made of translucent material so that the light of the LED indicator (10) can penetrate the PET gasket (1) and indicate the charging state. The positive contact chip (9) passes through the middle of the steel sleeve (2) and the PET gasket (1), and a through hole notch is made on the side of the steel sleeve (2), which is aligned and connected with the universal charging and discharging base (11) interface. The whole battery is enclosed with the PET sleeve (7). The universal charging and discharging base (11) can include two types of Type-C and Micro USB. The rechargeable lithium-ion battery invented can be directly charged and discharged through the universal charging and discharging base via a USB cable, which is featured by simple and convenient charging and discharging, good and fast power transmission ability and short charging time. The LED indicator that indicates the charging state improves the convenience and practicability of the rechargeable battery. The steel sleeve integrates all parts of the battery as a whole and realizes negative electrode electricity conduction. The upper and lower brackets support and fix the protective plate, and also play an insulating role. The bottom gasket set at the lower end of the cell effectively protects the bottom of the battery from wear and deformation. The bottom gasket set at the lower end of the cell effectively protects the bottom of the battery from wear and deformation. The PET gasket is fixed at the top of the steel sleeve to play an insulating role. As the PET gasket is made of translucent material, the light of the LED indicator can penetrate the PET gasket and indicate the charging state.

Although the embodiment of the invention has been shown and described, it can be understood to those general technicians in this field that a variety of changes, modifications, substitutions and variants can be made to the embodiment without breaking away from the principle and spirit of the invention, and the scope of the invention is defined by the appended claims and their equivalents.

1. A rechargeable lithium-ion battery is characterized in that the rechargeable lithium-ion battery is composed of a PET gasket (1), a steel sleeve (2), an upper bracket (3), a protective plate (4), a lower bracket (5), a cell (6), a PET sleeve (7), a bottom gasket (8), a positive contact chip (9), an LED indicator (10) and a universal charging and discharging base (11); The lower bracket (5) and the bottom gasket (8) are respectively fixed at both ends of the cell (6). The upper end of the lower bracket (5) is fixed with the protective plate (4) that includes the positive contact chip (9) fixed in the middle of the surface, the LED indicator (10) installed near the positive contact chip (9), and the universal charging and discharging base (11) installed at the notch of the protective plate. The upper end of the protective plate (4) is fixed with the upper bracket (3), which is clamped with the lower bracket (5). The upper bracket (3) and the lower bracket (5) are enclosed with the steel sleeve (2), whose lower end is closely riveted with the negative shell at one end of the cell (6) head, and the upper end is fixed with the PET gasket (1). The PET gasket (1) is made of translucent material so that the light of the LED indicator (10) can penetrate the PET gasket (1) and indicate the charging state. The positive contact chip (9) passes through the middle of the steel sleeve (2) and the PET gasket (1), and a through hole notch is made on the side of the steel sleeve (2), which is aligned and connected with the universal charging and discharging base (11) interface. The whole battery is enclosed with the PET sleeve (7).
